(19) United States
(12) Patent Application Publication
(10) Pub. No.: US 2005/0174066 A1
(43) Pub. Date: Aug. 11, 2005

(54) CONTROL CIRCUIT OF SMALL NIGHT LAMP

(76) Inventor: Jen Yen Yen, Chang Hua Hsien (TW)

Correspondence Address: JEN YEN YEN, 235 CHUNG-HO BOX 8-24, TAIPEI HSIEN, 235, TW

(21) Appl. No.: 10/773,854

(22) Filed: Feb. 9, 2004

(51) Int. Cl. H05B 39/04

(52) U.S. Cl. 315/291; 315/224

(57) ABSTRACT

A control circuit of a small night lamp comprises a power circuit having a battery, a solar cell, the battery being installed with a switch for controlling the turning on and off of the power; a sound sensing circuit having a sound pickup, two transistors; the sound pickup serving to sense sounds and then to conduct the transistors; a light circuit having a plurality of LED lights; and a main control circuit having a microprocessor which is connected to the sound sensing circuit and the LED lights; the main control circuit being actuated by the transistors of the sound sensing circuit; when the main control circuit is actuated, all the LED lights lighting up or the LED lights lighting up in turn.

### FIELD OF THE INVENTION

The present invention relates to night lamps, and particular to a control circuit of a small night lamp where a sound control function is added to the night lamp for actuation LED lights to light up or extinguish.

### BACKGROUND OF THE INVENTION

In the prior art night lamps, a tungsten silk bubble is installed in a box body with a power switch and a plug. Then the plug is connected to an AC power supply. The tungsten silk can light up as power is actuated from the plug and turned off as no power is supply. However, the prior art has the following disadvantages.

The bubble has a larger volume and consumes more power. Thus, it is only used with AC power supply. Thereby, the user of the prior art night lamp is inconvenient. It is often fixed to one place, not portable. The switch is controlled by hands. The light of the bubble is fixed so as to have a dull appearance. The volume of the prior art night lamp is large and thus it can be not used in many fields, such as used as a treading pad.

### SUMMARY OF THE INVENTION

Accordingly, the primary object of the present invention is to provide a control circuit of a small night lamp which comprises a power circuit having a battery, a solar cell, the battery being installed with a switch for controlling the turning on and off of the power; a sound sensing circuit having a sound pickup, two transistors; the sound pickup serving to sense sounds and then to conduct the transistors; a light circuit having a plurality of LED lights; and a main control circuit having a microprocessor which is connected to the sound sensing circuit and the LED lights; the main control circuit being actuated by the transistors of the sound sensing circuit; when the main control circuit is actuated, all the LED lights lighting up or the LED lights lighting up in turn.

The various objects and advantages of the present invention will be more readily understood from the following detailed description when read in conjunction with the appended drawing.

### BRIEF DESCRIPTION OF THE DRAWINGS

FIG. 1 shows the control circuit of the present invention.

FIG. 2 shows the control circuit of the power circuit with an AC power supply.

FIG. 3 shows the control block of the present invention.

FIG. 4 shows one application of the present invention, where the present invention is installed in a box body.

FIG. 5 is an assembled view of the treading pad of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

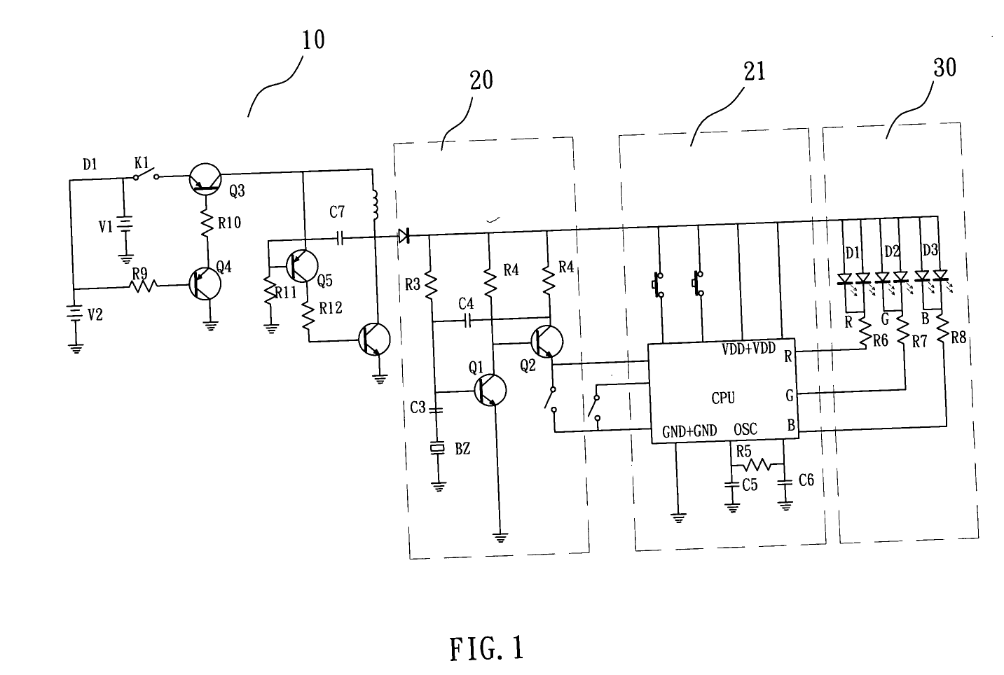

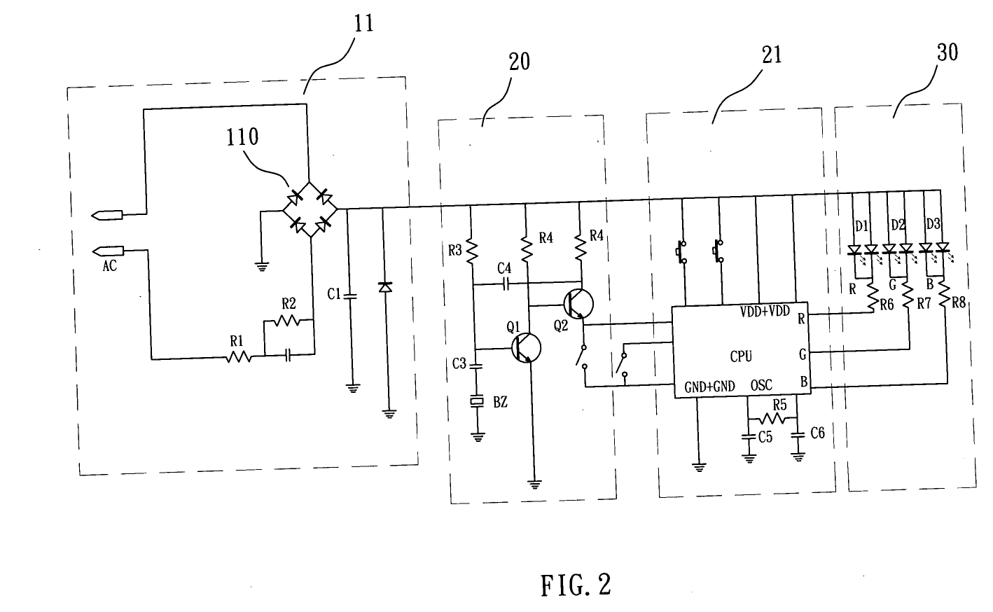

With reference to FIGS. 1 and 2, the control circuit of a small night lamp of the present invention is illustrated. The control circuit of a small night lamp comprises the following elements.

A power circuit 10 has a battery V1, a solar cell V2, the battery V1 is installed with a switch K1 for controlling the turning on and off of the power;

A sound sensing circuit 20 has a sound pickup BZ, two transistors Q1 and Q2. The sound pickup BZ serves to sense sounds and then to conduct the transistors Q1 and Q2;

A light circuit 30 has a plurality of LED lights D1, D2 and D3; and

A main control circuit 21 has a microprocessor CPU which is connected to the sound sensing circuit 20 and the LED lights D1, D2 and D3; the main control circuit 21 is actuated by the transistors Q1 and Q2 of the sound sensing circuit 20; when the main control circuit 21 is actuated, all the LED lights D1, D2 and D3 light up or the LED lights D1, D2 and D3 light up in turn.

The operation and advantages of the present invention will be described here.

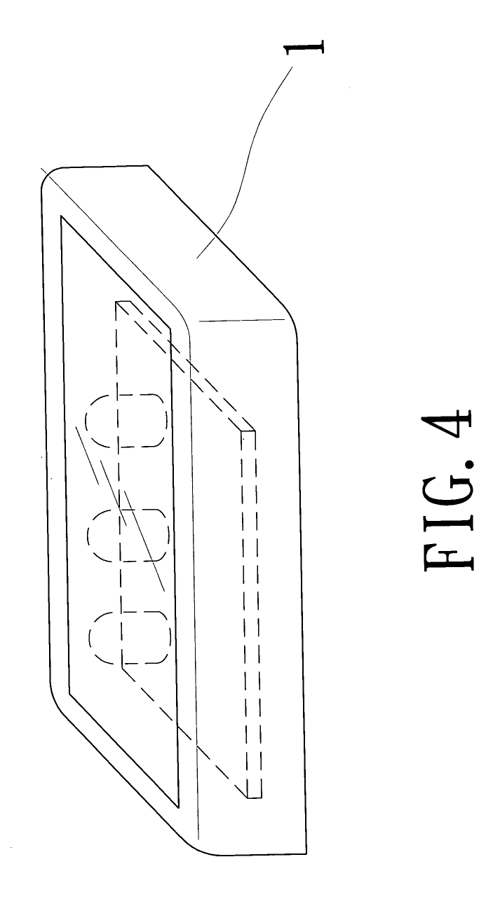

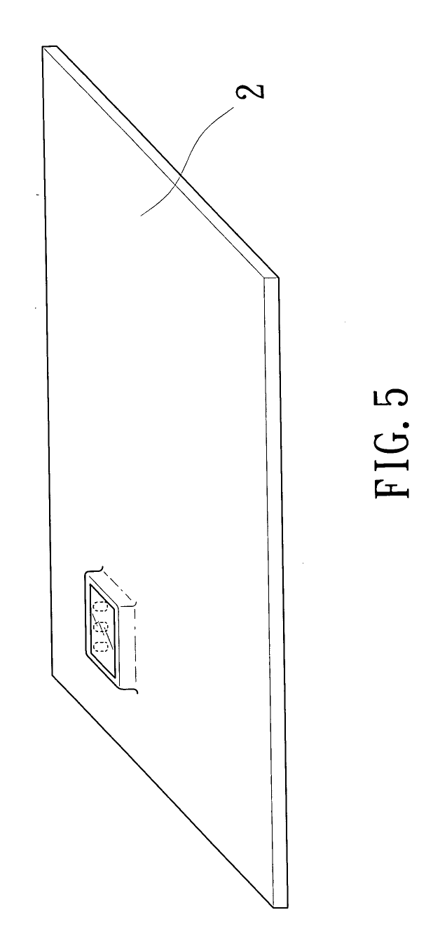

The LED lights D1, D2 and D3 consume a small amount of power and have a small volume so that it can be made in a small circuit board. Therefore, power can be supplied from batteries and can be assembled in a box body (referring to FIG. 4) so that it can be placed anywhere instead of only being located near an AV power supply. For example, the present invention can be assembled to a treading pad 2 as shown in FIG. 5 so as to clean the soles of shoes. Thereby, it has the function of lighting and indication.

Power is supplied from the battery V1 and the solar cell V2. Thus power is saved.

For the power turning on and off, when it is desired to light up the LED lights D1, D2 and D3, a larger sound (for example, applause) is emitted so that the sound pickup BZ can sense the sound to actuate the transistors Q1 and Q2. When it is desired to stop the LED lights D1, D2 and D3, a larger sound is emitted again so that the resist of the sound pickup BZ is changed to turn off the transistors Q1 and Q2.

By above mentioned auto-sensing, the microprocessor CPU of the main control circuit 21 can accept a signal from the transistors Q1 and Q2 so as to actuate or de-actuate the LED lights D1, D2 and D3. Namely, the lighting up of the LED lights D1, D2 and D3 is sound-controlled. Thus, the use of the present invention is very easily.

In the present invention, the microprocessor CPU of the main control circuit 21 is connected to the LED lights D1, D2 and D3, the colors of LED lights D1, D2 and D3 can be selected from red light, green light, blue light, yellow lights, white light, etc. Moreover, the lighting sequence of the LED lights D1, D2 and D3 can be selected from all lighting up or lighting up sequentially so as to present various light effect as the desire of users.

The use of LED lights D1, D2 and D3 save more power. Thus DC power can be used and the present invention can be used outdoors. No power leakage occurs, which is often induced in AC power. Thereby, the present invention can be place anywhere and can be used as road and direction indication.

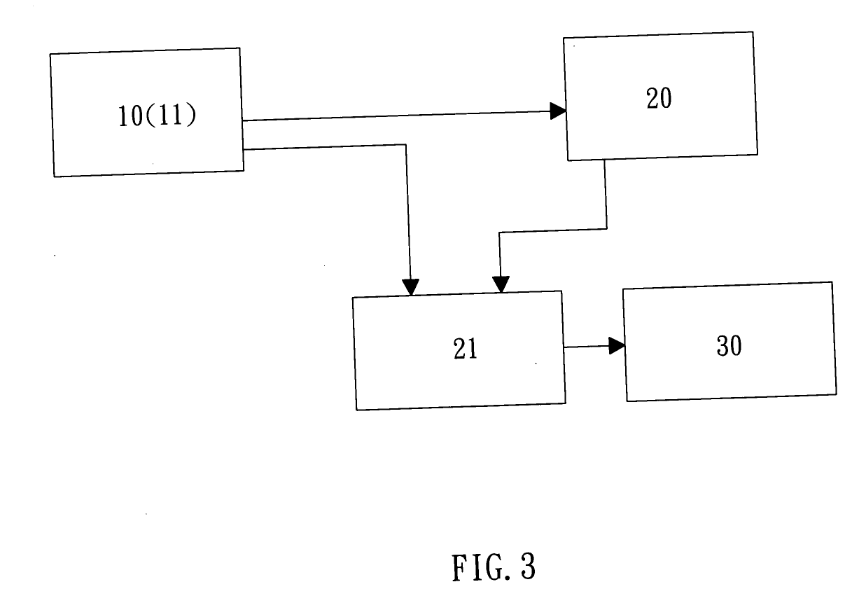

With reference to FIG. 3, the power supply of the present invention can be realized as those shown in FIG. 3. In that the power circuit 10 is a rectifier 11 for rectifying AC power into DC power.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A control circuit of a small night lamp comprising:
a power circuit having a battery, a solar cell, the battery being installed with a switch for controlling the turning on and off of the power;
a sound sensing circuit connected to the power circuit and having a sound pickup, two transistors; the sound pickup serving to sense sounds and then to conduct the transistors;
a light circuit having a plurality of LED lights; and
a main control circuit connected between the sound sending circuit and the light circuit; the main control circuit having a microprocessor which is connected to the sound sensing circuit and the LED lights; the main control circuit being actuated by the transistors of the sound sensing circuit; when the main control circuit is actuated, all the LED lights lighting up or the LED lights lighting up in turn.

2. The control circuit of a small night lamp as claimed in claim 1, wherein the power circuit includes a rectifier for rectifying AC current in DC current.
